(19) United States
(12) Patent Application Publication
(10) Pub. No.: US 2025/0137897 A1
(43) Pub. Date: May 1, 2025

(54) DEVICE FOR SIMULATING THE BEHAVIOUR OF A MAMMALIAN LIMB ON THE GROUND

(71) Applicants: INSTITUT NATIONAL DE RECHERCHE POUR L’AGRICULTURE, L’ALIMENTATION ET L’ENVIRONNEMENT, Paris (FR); ECOLE NATIONALE VÉTÉRINAIRE D’ALFORT, Maisons-Alfort Cedex (FR); INSTITUT FRANÇAIS DU CHEVAL ET DE L’EQUITATION, Saumur Cedex (FR)

(72) Inventors: Nathalie CREVIER-DENOIX, Joinville le Pont (FR); Franco Miller MUNOZ NATES, Maisons-Alfort (FR); Philippe POURCELOT, Veigné (FR); Claude DARDILLAT, PARIS (FR)

(21) Appl. No.: 18/836,678

(22) PCT Filed: Feb. 7, 2023
(86) PCT No.: PCT/EP2023/052914

§ 371 Date: Aug. 7, 2024

(30) Foreign Application Priority Data
Feb. 7, 2022 (FR) FR2201031

(51) Int. Cl. G01N 3/48

(52) U.S. Cl. CPC G01N 3/48

(57) ABSTRACT

A device (1) for simulating the behaviour of a mammalian limb, in particular that of an equine mammal, on the ground, includes an impactor (5) in contact with the ground and intended to compress the ground. The device has a mass (7) movable along a vertical rectilinear axis, a sensor (9) for measuring the vertical force applied to the impactor, and a device (10) for measuring the penetration of the impactor in the ground, under the effect of the movement of the mass (7). The device can include a vertical shaft connected to the impactor at its lower end, and also one or more stops placed on one or more vertical rods along which the mass moves, the one or more vertical rods being connected to the vertical shaft by one or more elastic members.

### TECHNICAL FIELD

The present invention relates to the study of the quality of sportsgrounds with a view to minimizing sporting accidents and/or increasing comfort when using these sportsgrounds.

For example, with reference to horse racing, it is known that accident rates for racehorses and sport horses are high. For example, it has been demonstrated that there is a causal link between the hardness of a training track and the occurrence of limb injuries in trotter samples, as explained in the article “Effect of track surface firmness on the development of musculoskeletal injuries in French Trotters during four months of harness race training” (Crevier-Denoix et al., American Journal of Veterinary Research, November 2017).

Track quality is a risk factor in injuries to the musculoskeletal system in racehorses and sport horses. In addition to the economic impact of these injuries for professionals in the field, the notion of risk related to the sportsground is becoming increasingly unacceptable in terms of animal welfare. Professionals in the equine sector need tools to objectively assess this risk. More generally, there is a need to be able to qualify equestrian surfaces, in order to plan and implement renovation and maintenance work, or to determine the suitability of a ground in consideration of the intended objectives.

### PRIOR ART

The measurements taken on equestrian surfaces are currently very basic and are not very representative of loads applied by the limb of a horse. This is for example the case with surface hardness of thoroughbred racetracks, which are evaluated using very simple devices such as penetrometers, in some countries. This measurement is intended to inform bettors of the condition of the sportsground.

A device developed in the United States, known as the Orono Biomechanical Surface Tester (OBST. Peterson et al., 2008) is known, but has the drawback that the application speed of the load on the ground is not physiological, but much greater than the physiological speed, notably ten times greater. As a result, the obtained results cannot be transposed. Furthermore, the device uses an oblique impact and includes a gas spring, which risks disturbing the vertical component of the compression of the ground. Furthermore, this device does not provide any direct measurement of the penetration of the impactor into the ground, which makes it impossible to determine the stiffness of the ground.

The few devices available to date therefore do not load the ground in the same way as the limbs of a horse during a race or a sporting event.

The preparation and maintenance of tracks and sportsgrounds are currently based essentially on the impressions of users and the experience of track managers, i.e. on a subjective evaluation by experts. The absence of objective measurements may result in conflict situations, and even lawsuits in the event of accidents, between the race and competition organizers, and the trainers and horse owners. Objective measurements would make it possible to demonstrate the good condition of the sportsgrounds, taking animal welfare into consideration.

There is therefore a need for a device that reproduces the bearing phase of the stride of a mammal, enabling the accident risk of a sportsground to be evaluated.

### SUMMARY OF THE INVENTION

The invention therefore relates, according to one of the aspects thereof, to a device for simulating the behavior on the ground of a limb of a mammal, notably of an equine mammal, having:
an impactor, notably in contact with the ground, that is intended to compress the ground,
notably a vertical shaft connected to the impactor at the lower end thereof,
a mass that is movable along a vertical rectilinear shaft and is notably intended to cause the descent of the impactor into the ground,
one or more stops placed on one or more vertical rods along which the mass moves, the vertical rod or rods being connected to the vertical shaft by one or more elastic members,
a sensor for measuring the vertical force applied to the impactor,
a device for measuring the penetration of the impactor into the ground, under the effect of the movement of the mass.

The device can comprise a vertical shaft connected to the impactor at the lower end thereof, and also one or more stops placed on one or more vertical rods along which the mass moves, the vertical rod or rods being connected to the vertical shaft by one or more elastic members.

Since the elastic member or members are connected on one hand to the mass, by means of the rod or rods fitted with nuts, and on the other hand to the vertical shaft, which is rigidly connected to the impactor, decelerating the vertical descent of the mass, the elastic member or members decelerate the compression of the ground by the impactor.

The device according to the invention enables the bearing behavior of the limb on the ground to be simulated. The impactor is configured to simulate the lower part of the limb, such as the hoof of a horse.

When the mass moves, the impactor can compress and penetrate the ground. It can execute a first compression, followed by one or more rebounds on the ground, notably under the effect of the movement of the mass, which may itself execute a first descent followed by one or more rebounds. The mass can move back up spontaneously.

The simulation device according to the invention can notably reproduce the vertical load applied on the ground by the front limb of a horse under sporting conditions. This makes it possible to analyze the stiffness of the ground for different levels of load, the stiffness in the vicinity of the maximum force being the most critical for the mammal.

### SUMMARY OF THE INVENTION

The simulation device can be configured to enable measurements to be taken for the first compression and/or for the rebounds.

The impactor may have a lower surface intended to be in contact with the ground. The lower surface of the impactor need not be entirely flat. It may for example have a curvature reproducing the shape of the bearing surface on the ground of the limb of the mammal.

The impactor may have a rear surface including a notch. The presence of the notch may for example reproduce the shape of the limb of the mammal, for example of the hoof of a horse.

The impactor may have an upper surface on which is formed a seat intended to receive the force sensor.

The impactor may be in contact with the ground throughout usage of the simulation device, including before the mass is moved.

The force measurement sensor may be uniaxial.

The simulation device may for example be used on sportsgrounds such as equestrian tracks in order to realistically simulate the loading of the ground by the front limb of a horse, under sporting and physiological conditions.

The simulation device can enable a progressive loading of the ground, for example over several tenths of milliseconds, while reaching high maximum force values, for example 1 to 1.5 tons, in line with measurements taken on horses in training. The simulation device can thus make it possible to obtain reproducible and differentiating force measurements related to a physiological loading of the ground.

The simulation device may be configured so that the maximum vertical force obtained by the descent of the mass is greater than 4000 N. The maximum vertical force may be high, being notably greater than 6000 N, or even greater than 8000 N, or better still greater than 9000 N, being for example in the order of 10,000 N, notably if the mammal is an equine mammal. In the case of a canine mammal, for example, the maximum vertical force may be notably greater than 100 N, or even greater than 300 N, or better still greater than 600 N, being for example in the order of 900 N.

In the case of a human, for example, the maximum vertical force may notably be greater than 700 N, or even greater than 1000 N, or better still greater than 1500 N, being for example in the order of 2000 N.

The mass is configured so that the vertical force obtained is comparable to the biometric variables of the mammal.

The simulation device may include a vertical shaft along which the mass moves. The vertical shaft may be connected to the impactor at the lower end thereof. The vertical shaft may be movable in vertical translation, driving the movement of the impactor. The device may be configured to allow the impactor to move vertically.

The device may include a device for measuring the penetration of the impactor into the ground including a movement sensor, notably a linear potentiometer. The device for measuring the penetration of the impactor into the ground may be configured to measure a vertical movement.

The device can make it possible to take a direct measurement of the penetration of the impactor into the ground.

The device for measuring the penetration of the impactor into the ground may be fastened to a chassis of the simulation device, which can remain immobile during the simulation. It may be fastened at the top of the simulation device on a bracket of the chassis.

The device for measuring the penetration of the impactor into the ground may further include a wire hooked onto a fixed point on the vertical shaft. The variation in the length of this wire causes a variation in the tension in volts read at the terminals of the potentiometer. This variation provides a movement distance of the vertical shaft.

The movement of the mass may include a first freefall descent portion, for example over a distance L, notably between 20 cm and 50 cm, or better still between 25 cm and 40 cm, being for example in the order of 30 cm. The descent height of the mass is configured so that the vertical force obtained is comparable to the biometric variables of the mammal.

The value of the mass may be between 10 kg and 1000 kg, notably between 20 kg and 500 kg, or even between 30 kg and 300 kg, or better still between 50 kg and 200 kg, being for example 110 kg. The mass may for example include, in one embodiment, a stack of five 20 kg rings and one 10 kg ring.

The value of the mass and the descent height of the mass are configured so that, when combined, the vertical force obtained is comparable to the biometric variables of the mammal.

The first freefall descent portion may be limited by one or more stops. For this purpose, the simulation device may have one or more stops, notably placed on one or more vertical rods along which the mass moves.

In one embodiment, the device may include two vertical rods that are parallel to each other, each having one stop. The stop may be placed at the distance L from the starting position of the mass, before the vertical freefall movement thereof.

A stop may include a nut fastened to the corresponding vertical rod.

The movement of the mass may include a second decelerated vertical descent portion. The deceleration may be obtained by the action of one or more elastic members from which are suspended the vertical rods provided with the stop or stops against which the mass abuts at the end of the freefall descent thereof. At the end of the freefall descent thereof, the mass pulls on the elastic member or members, and the descent thereof is thus decelerated. The elastic member or members may be configured so that the vertical force reaches a maximum value in a time comparable to the biometric variables of the mammal.

The vertical rod or rods may be connected to the vertical shaft by one or more elastic members. The elastic member or members may include an elastic material, for example a ribbon of elastic material.

The elastic material may be non-metallic, notably plastic, for example latex.

Once prepared, the elastic material may be used to form the elastic member or members enabling the descent of the mass, and therefore the compression of the ground, to be decelerated.

The elastic member or members may have an overall stiffness of between 50,000 N/m and 500,000 N/m, or better still between 100,000 N/m and 200,000 N/m, for example in the order of 150,000 N/m.

The elastic member is elongated under the effect of the descent of the mass. This replicates the elasticity of the limb of the mammal.

The elastic members may be rigidly connected to the vertical shaft by a plate, which may be connected to the vertical shaft by a pin.

A downward movement of the elastic member or members may drive the movement of the vertical shaft, via the plate.

The elongation of the elastic member or members may be equal to the distance travelled by the mass, along the shaft, during the second portion of the decelerated vertical descent movement thereof.

When the mass moves, the impactor can compress and penetrate the ground. It can execute a first compression, followed by one or more rebounds on the ground, notably under the effect of the movement of the mass, which may itself execute a first descent followed by one or more rebounds. The mass can move back up spontaneously.

The simulation device can be configured to enable measurements to be taken for the first compression and/or for the rebounds.

The simulation device may be configured so that the compression speed of the ground is between 50 kN/s and 500 kN/s. The compression speed of the ground may notably be less than 400 kN/s, or even less than 300 kN/s, or better still less than 200 kN/s.

The mass is configured so that the compression speed of the ground obtained is comparable to the biometric variables of the mammal.

The simulation device can notably make it possible to measure the stiffness of the ground, which corresponds to the slope of the plot of the vertical force as a function of the penetration of the impactor into the ground.

The simulation device may be configured to provide the average stiffness of the ground, which is the ratio of the maximum vertical force to the corresponding penetration of the impactor into the ground. The stiffness of the ground can be a characteristic parameter of a given ground that is highly differentiating when determining the accident risk of a ground. The stiffness of the ground may be specific to a given ground in a given condition. The average stiffness of the ground may be less than 3000 kN/m, or better still less than 2500 kN/m, or even less than 2000 kN/m.

As a variant or additionally, the simulation device may be configured to provide the segment stiffnesses for different force levels, in particular for the greatest forces.

The simulation device may be configured to provide the damping coefficient of the ground, from the slope of the straight line passing through the vertices of the consecutive peaks of the vertical force, during consecutive impacts and rebounds. The damping coefficient of the ground represents the energy return from the ground to the mammal, notably to the horse. It is calculated using the rebounds of the impactor into the ground. The damping coefficient can make it possible to predict the capacity of a ground to be compacted under the effect of the rebounds of the impactor.

Knowing the stiffness of the ground and this damping coefficient can make it possible to issue suitable maintenance recommendations for the ground of a sportsground, notably of an equestrian sportsground, notably short-term maintenance recommendations for the ground. “Short-term” means that these recommendations are to be carried out within 10 hours, or even within 8 hours, or better still within 6 hours, or even better still within 4 hours.

Application of these recommendations is intended on one hand to improve the performance of the ground, notably in sporting terms, and on the other hand to minimize the risk of accidents.

The device according to the invention makes it possible to measure at least several of the reproducible and differentiating parameters selected from the following list: vertical force, maximum vertical force, penetration of the impactor into the ground, maximum penetration of the impactor into the ground, average stiffness and segment stiffnesses, recoil of the ground following impact, damping coefficient of the ground. The average stiffness of the ground can advantageously be deduced from the measurements of the maximum vertical force and of the corresponding penetration of the impactor into the ground.

The simulation device can make it possible to simulate the behavior on the ground of a limb of a mammal, notably of an animal mammal, notably of an equine mammal, in particular of a horse. The animal mammal may be an equine animal, and preferably a horse. The limb may be a front limb of a mammal, notably of an animal mammal, notably of an equine mammal, in particular of a horse. The mammal may thus be an animal.

In a variant, the mammal may be a human, for example a sports person such as a runner, association footballer or rugby footballer.

The device may be configured to be movable, notably having wheels, for example two wheels on which a chassis of the device is mounted.

The device may be motorized, or in a variant be configured to be moved by a motorized vehicle, for example a quad, tractor, or other. The chassis may include coupling means for this purpose.

The device may be configured to enable consecutive measurements to be taken, separated by an interval of time of less than 15 minutes, or better still less than 12 minutes, or even less than 10 minutes, or even better less than 5 minutes, for example every 2 to 4 minutes, notably every 3 minutes. A short interval of time ensures sufficient measurement speed to carry out a sufficient number of measurements over a large sportsground, within a reasonable time, for example less than 5 hours, notably 1 hour, or 2 to 3 hours for a sportsground that may for example have a surface area in the order of 6000 m² to 8000 m². For example, around ten measurements can be taken in less than one hour.

The invention also relates, independently or in combination with the foregoing, to a method for determining the accident risk of a sportsground, notably an equestrian sportsground, wherein at least one of the parameters from the following list is measured, notably using a simulation device as described above: vertical force, maximum vertical force, penetration of the impactor into the ground, maximum penetration of the impactor into the ground, recoil of the ground following impact, average stiffness and segment stiffnesses, and damping coefficient of the ground.

The sportsground may for example be chosen from the following list, which is not limiting: equestrian sportsground, racetrack at a racecourse, training track, arena, riding school, or paddock. The sportsground may in a variant be a running track or a team sportsground, for example an association football or rugby pitch.

This method can determine an accident risk of the sportsground used by mammals, notably the equestrian sportsground, using the measured parameter or parameters.

“Accident risk” means that the use of the sportsground under sporting conditions may increase the likelihood of the user mammal suffering an accident.

The accident risk is acceptable if for example the average stiffness of the ground is less than 3000 kN/m, or better still less than 2500 KN/m, or even less than 2000 kN/m.

The method may be implemented in order to suggest or prescribe maintenance recommendations suitable for the ground of the sportsground, notably the equestrian sportsground, notably short- or medium-term maintenance recommendations for the ground. The maintenance recommendations may include watering, harrowing, decompacting, drainage, keeping in the shade, or conversely exposing to the sun (this list is not exhaustive).

The method may be implemented to draw up a map of the sportsground as a function of the measurements taken and the locations thereof.

Possible applications include the preparation and maintenance of racetracks, for example for trotters or thoroughbreds, as well as of eventing arenas, obstacle jumping or dressage arenas, in order to guarantee the safety of these sportsgrounds and to increase the comfort of use thereof.

The users of the simulation device and of the method according to the invention may be professionals specialized in the maintenance of equestrian tracks, managers of racetracks and thoroughbred or trotter training centers, managers of eventing arenas, surface manufacturers, or sports surface inspectors (this list is not exhaustive).

### BRIEF DESCRIPTION OF THE DRAWINGS

The invention is further explained in the detailed description given below of non-limiting example embodiments of the invention and the attached drawings, in which:

FIG. 1 is a partial schematic perspective view of a simulation device according to the invention.

FIG. 2 is a partial schematic perspective view of the simulation device in FIG. 1.

FIG. 3 is a partial schematic side view of the simulation device in FIG. 1.

FIG. 4 is a partial schematic front view of the simulation device in FIG. 1.

FIG. 5 is a partial schematic front view of the simulation device in FIG. 1, before a test.

FIG. 6 is a partial schematic front view of the simulation device in FIG. 1 in operation.

FIG. 7 shows the evolution over time of the vertical force during operation of the simulation device in FIG. 1.

FIG. 8 shows the evolution over time of the penetration of the impactor into the ground during operation of the simulation device in FIG. 1.

FIG. 9 shows the evolution of the vertical force, up to the maximum vertical force Fz max, as a function of the penetration of the impactor into the ground during operation of the simulation device in FIG. 1. The slope of the plot corresponds to the stiffness of the ground.

FIG. 10 illustrates the stiffness of the ground for different sportsgrounds.

FIG. 11 shows the evolution over time of the vertical force during operation of the simulation device in FIG. 1, with several rebounds.

### DETAILED DESCRIPTION

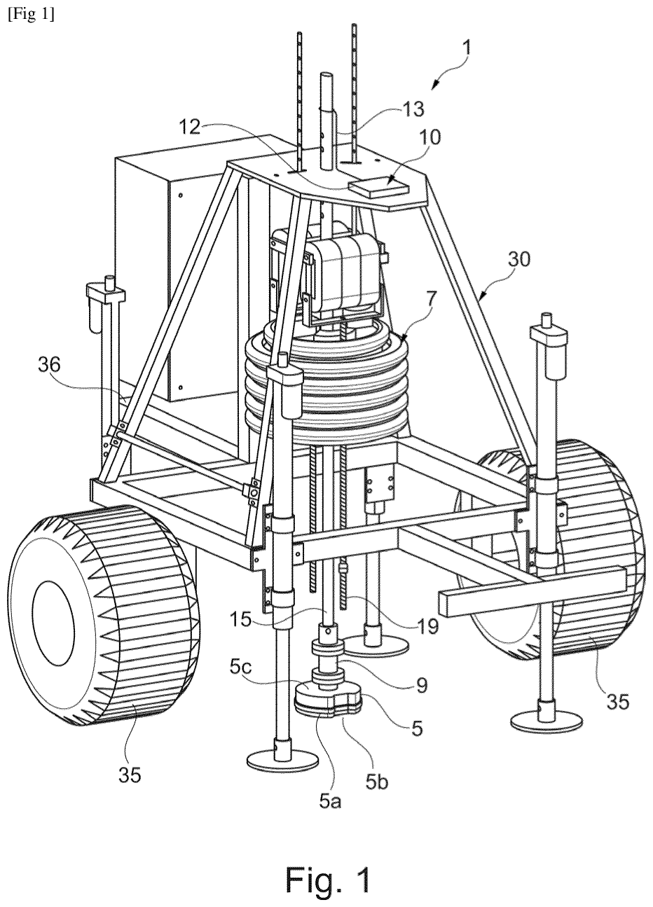

FIGS. 1 to 6 illustrate a device 1 for simulating the behavior on the ground of a limb of an equine mammal, according to the invention. This simulation device 1 is intended to be used on sportsgrounds such as equestrian tracks in order to realistically simulate the loading of the ground by the front limb of a horse, under sporting and physiological conditions.

The device 1 includes an impactor 5 in contact with the ground S that is intended to compress the ground, as well as a mass 7 movable along a vertical rectilinear shaft, a sensor 9 for measuring the vertical force applied to the impactor, and a device 10 for measuring the penetration of the impactor into the ground, under the effect of the movement of the mass 7.

The device 1 according to the invention enables the bearing behavior on the ground of the limb to be simulated. The impactor 5 is intended to simulate the hoof of a horse. It has a lower surface 5a that is intended to be in contact with the ground, which is not entirely flat, having a curvature that reproduces the shape of the bearing surface of the hoof of the horse on the ground. Furthermore, the impactor has a rear surface including a notch 5b that reproduces the shape of the hoof of the horse, as shown in FIG. 1. The impactor also has an upper surface 5c on which is formed a seat to receive the end of a vertical shaft 15, which includes the force measurement sensor 9. The force measurement sensor 9 is uniaxial.

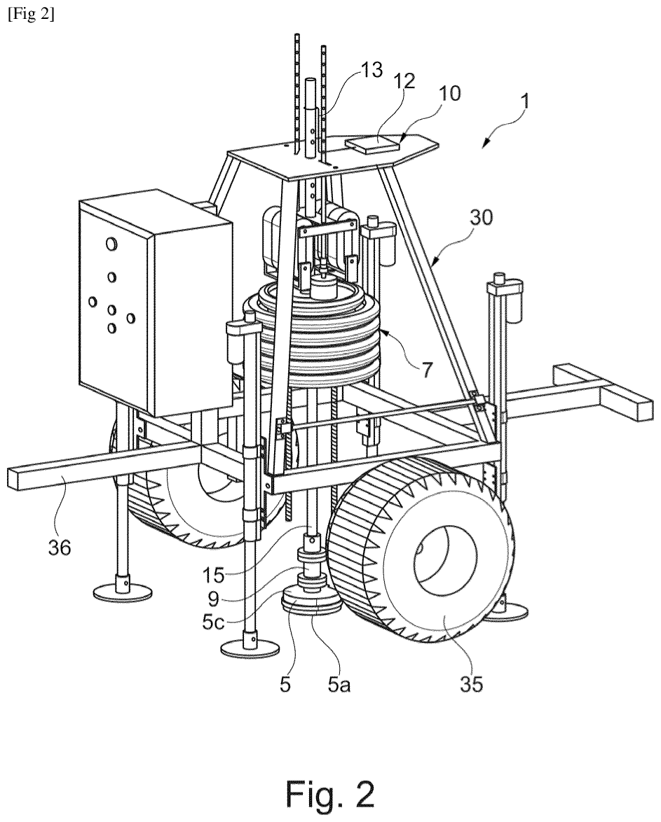

The mass 7 is configured so that the vertical force obtained is comparable to the biometric variables of the mammal. It includes in this example a stack of five 20 kg rings and one 10 kg ring, as shown for example in FIG. 2. Consequently, the maximum vertical force generated on the ground is in the order of 10,000 N.

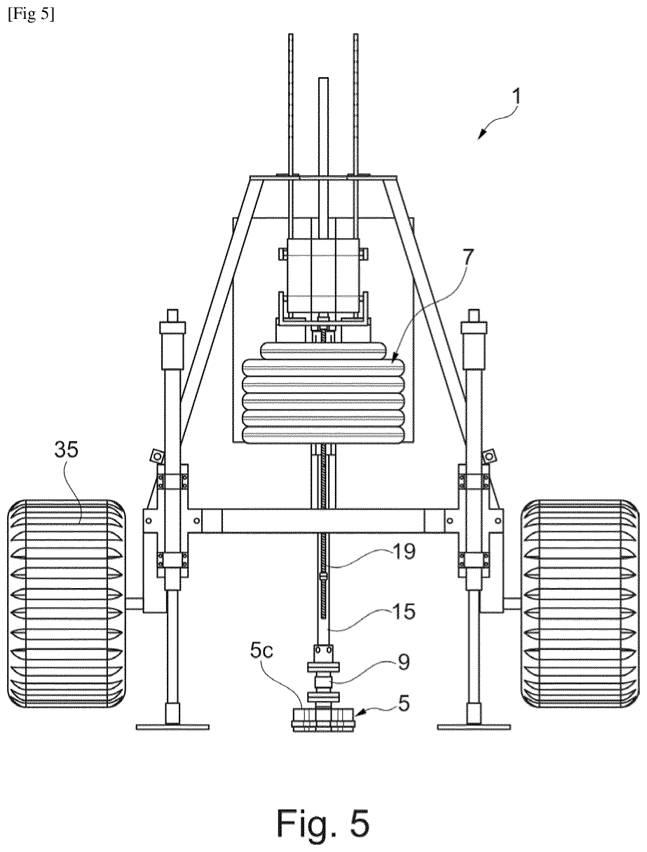

FIG. 5 shows the chassis and the impactor in a position ready for operation. Four jacks lowered to rest on the ground are shown. The mass 7 is held by electromagnets rigidly connected to the chassis to guarantee the intended descent height for the mass.

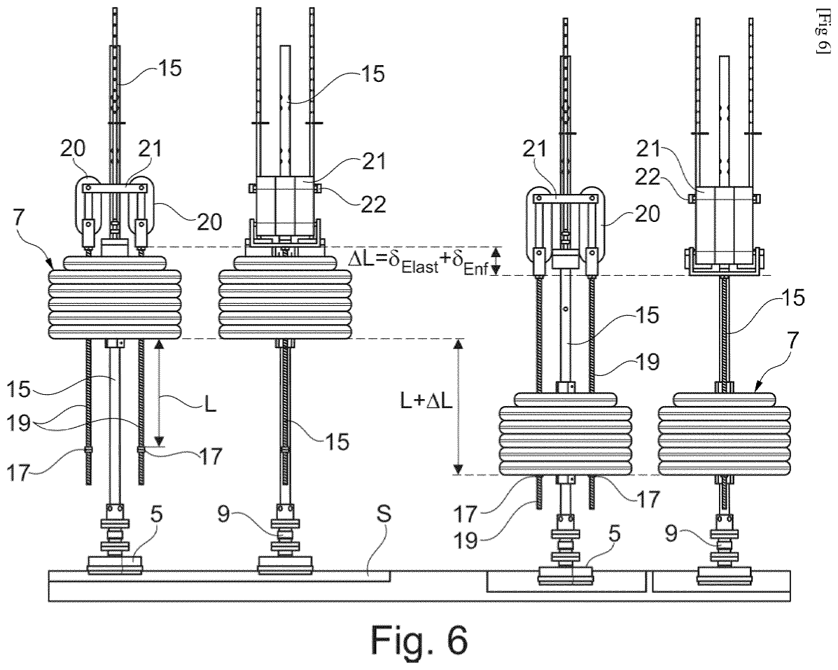

When the mass 7 moves, the impactor 5 compresses and penetrates the ground S, as shown in FIG. 6.

The impactor 5 executes a first compression followed by rebounds on the ground, under the effect of the movement of the mass 7, which itself executes a first descent followed by rebounds, as shown in FIG. 11. The mass moves back up spontaneously. The simulation device 1 is configured to enable measurements to be taken for the first compression and for the rebounds.

The simulation device 1 enables a progressive loading of the ground, for example over several tenths of milliseconds, while reaching high maximum force values, for example 1 to 1.5 tons, in line with measurements taken on horses in training.

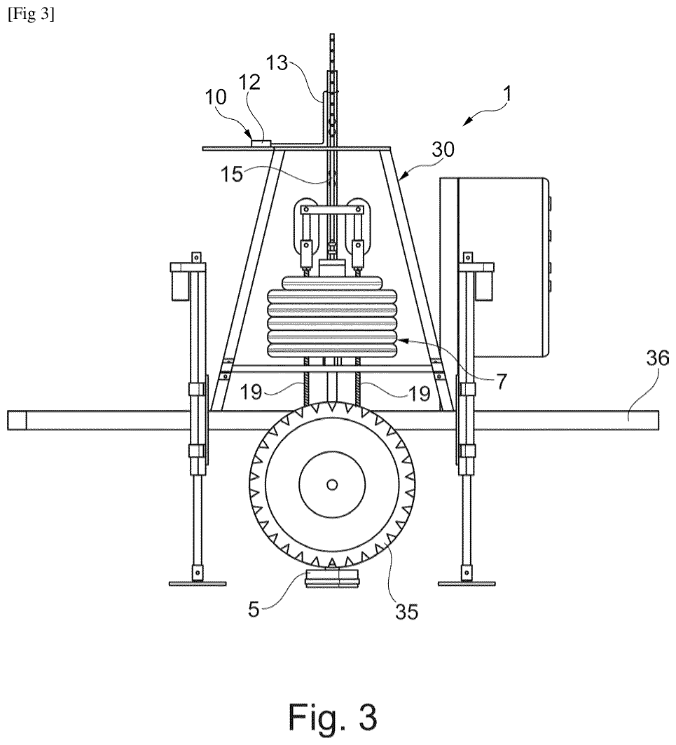

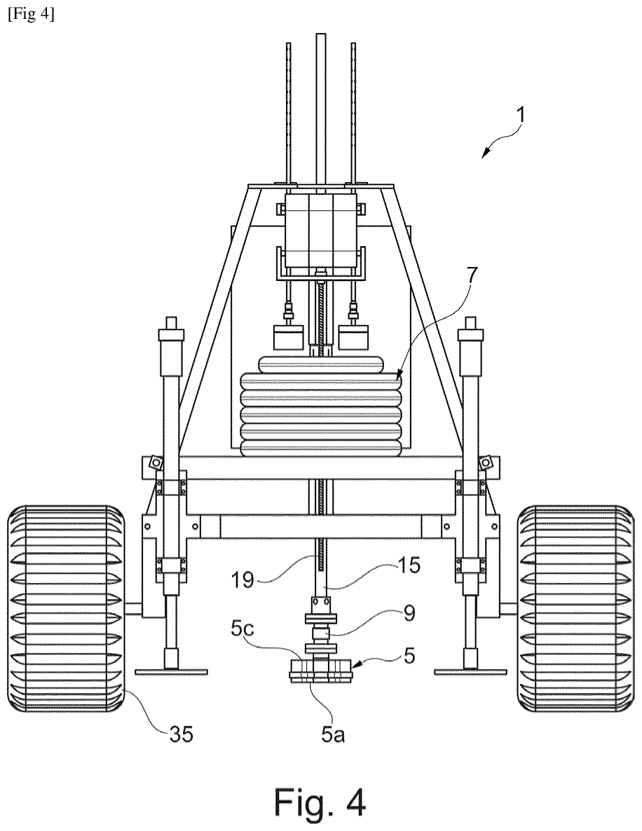

For this purpose, the simulation device 1 includes a vertical shaft 15 along which the mass 7 moves, as shown in FIGS. 3 and 4. The vertical shaft 15 bears against the impactor 5 via the lower end thereof. It is movable in vertical translation, driving the movement of the impactor 5.

The movement of the mass includes a first freefall descent portion over a distance L, which is for example in the order of 30 cm.

The first freefall descent portion is limited by stops 17, each of which is formed by a nut. A stop is placed on a vertical rod 19 along which the mass 7 moves. The device thus includes two vertical rods 19 that are parallel to one another, each having a stop 17. Each stop 17 is placed at the distance L from the starting position of the mass, before the vertical freefall movement thereof.

The movement of the mass 7 includes a second decelerated vertical descent portion. The deceleration is obtained by the action of elastic members 20 from which are suspended the vertical rods 19 and the stops 17 against which the mass 7 abuts at the end of the freefall descent thereof. Thus, at the end of the freefall descent thereof, the mass pulls on the elastic members 20, and the descent thereof is thus decelerated. The elastic member is elongated under the effect of the descent of the mass. This replicates the elasticity of the limb of the mammal.

The elastic members 20 include an elastic material, for example latex, in ribbon form.

The elastic members 20 are rigidly connected to the vertical shaft 15 by a plate 21, which is connected to the vertical shaft 15 by a pin 22. A downward movement of the elastic members 20 thus drives the movement of the vertical shaft, via the plate 21, as clearly shown in FIG. 6.

The elongation δElast of the elastic member or members is equal to the distance travelled by the mass, along the shaft, during the second portion of the decelerated vertical descent movement thereof.

When the mass moves, the impactor 5 compresses and penetrates the ground.

In FIG. 6, the distance AL represents the positional change of the lower part of the elastics between two instants: before the mass is released and once the impactor has penetrated the ground. AL corresponds to the sum of the elongation of the elastics and of the descent of the vertical shaft, which itself corresponds to the penetration of the impactor into the ground (δEnf).

$$Therefore Δ L = δ Elast + δ Enf .$$

The penetration of the impactor is measured using the measurement device 10, which includes for this purpose a linear potentiometer 12 that is provided with a wire 13 hooked onto a fixed point on the vertical shaft 15. The variation in the length of this wire 13 causes of variation in the tension in volts read at the terminals of the potentiometer. This variation provides a movement distance of the vertical shaft 15.

The device 10 for measuring the penetration of the impactor into the ground is fastened to a chassis 30 of the simulation device 1, which remains immobile during the simulation. The measurement device 10 is fastened to a bracket placed at the top of the chassis 30.

The simulation device is designed to be movable, having two wheels 35 on which the chassis 30 is mounted. The device can then be moved by a motorized vehicle, for example a quad, tractor, or other. The chassis may include coupling means 36 for this purpose.

The device 1 thus makes it possible to take consecutive measurements separated by a short interval of time, for example every 2 to 4 minutes, which ensures sufficient measurement speed to carry out a sufficient number of measurements over a large sportsground, within a reasonable time. For example, around ten measurements can be taken in less than one hour.

The different parameters measured or calculated, which are reproducible and differentiating when qualifying a sportsground, are described below.

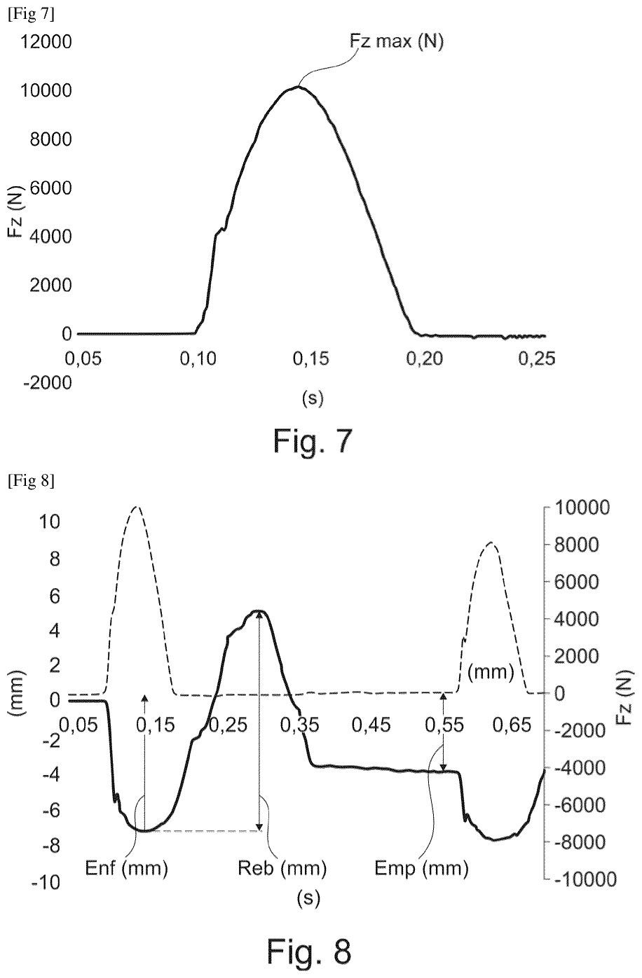

FIG. 7 shows the evolution over time of the vertical force Fz during operation of the simulation device 1. The time is expressed in seconds and the vertical force Fz in newtons. This graph shows the first impact, with the maximum vertical force Fz max reached, which is in the order of 10,000 N.

FIG. 8 shows the evolution over time of the penetration of the impactor 5 into the ground during operation of the simulation device 1. The time is expressed in seconds and the penetration in mm. This graph shows two bearings, specifically the first compression and the first rebound. The parallel evolution of the vertical force Fz in newtons is superposed using a dashed line.

The graph in FIG. 8 thus shows the penetration Enf of the impactor 5 during the first compression, given by the movement of the central shaft 15 measured on the shaft, then the height Reb of the rebound executed by the impactor, which represents the energy return from the ground following the first compression, and finally the outline of the imprint Emp left by the impactor on the ground.

The recoil of the ground following the impact can be obtained by calculating the difference between the maximum penetration of the impactor into the ground and the imprint.

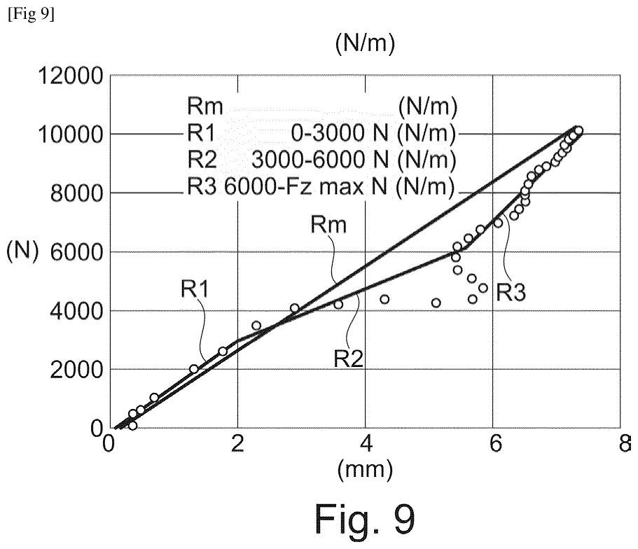

Measuring the vertical force and the penetration makes it possible to deduce the stiffness of the ground in kN/m, which corresponds to the slope of the plot of the vertical force Fz as a function of the penetration of the impactor into the ground, this slope being illustrated in FIG. 9. The average stiffness Rm, which is provided by the slope of the curve and which is calculated by the ratio of the maximum vertical force Fz max to the corresponding penetration Enf of the impactor into the ground, can then be deduced.

The stiffness of the ground is a characteristic parameter of a ground in a given condition that is highly differentiating when determining the accident risk of a ground.

Several segments within the Force-Penetration curve can be identified, and the slope can be calculated by segment to obtain a segment stiffness R1, R2, R3. A first segment R1 can be defined in which the force is for example between approximately 0 N and 3000 N, followed by a second segment R2 between 3000 N and 6000 N, and finally a third segment R3 in which the force is greater than 6000 N. A stiffness value is then calculated for each segment in kN/m, respectively the stiffnesses R1, R2, R3, and the average stiffness Rm, all expressed in kN/m.

The invention thus makes it possible to identify grounds exhibiting high stiffness for the greatest forces, i.e. for example in the third segment described above. The stiffness for the greatest forces is indeed the most hazardous for the horse, corresponding to the maximum loading phase of the limb when bearing on the ground.

The device described above thus makes it possible to determine the accident risk posed by a sportsground, for example an equestrian sportsground. For this purpose, at least one of the parameters from the following list is measured: vertical force, maximum vertical force, penetration of the impactor into the ground, maximum penetration of the impactor into the ground, recoil of the ground following impact, average stiffness and segment stiffnesses, and damping coefficient of the ground, as described above; the potential accident risk posed by the equestrian sportsground is then determined using the measured parameter or parameters, i.e. the risk that using the sportsground under sporting conditions will increase the likelihood of the horse suffering an accident.

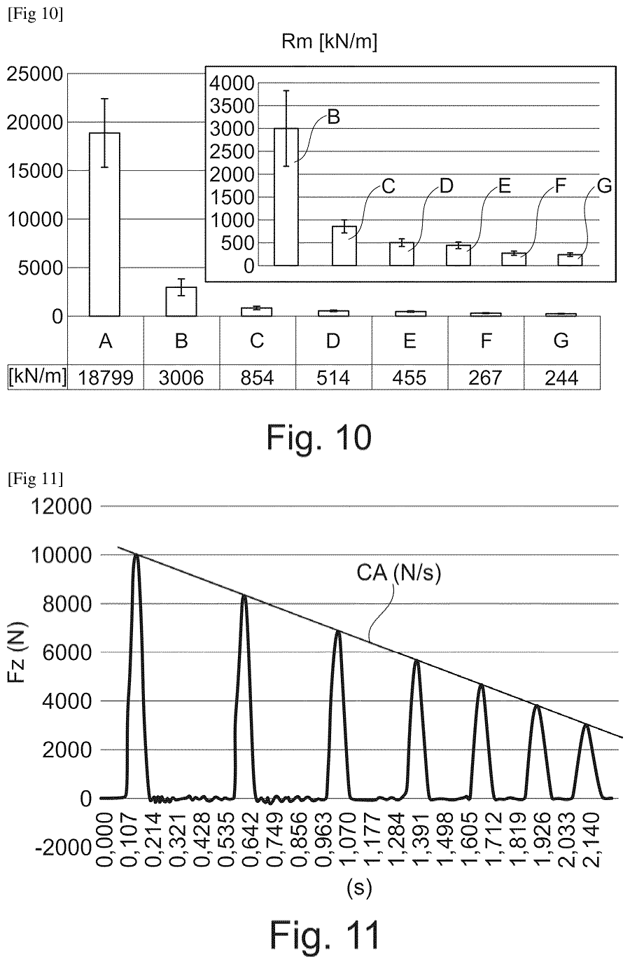

By way of example, FIG. 10 shows several stiffness values obtained on different sportsgrounds. The first sportsground A is an asphalted ground, the second B is an unmaintained hard sportsground of sharp sand, and the following ones (C to G) are different equestrian surfaces, for which the average stiffness of the ground is less than 3000 kN/m, better still less than 2500 kN/m, or even less than 2000 kN/m.

The method may be implemented in order to suggest or prescribe maintenance recommendations suitable for the ground of the sportsground, notably the equestrian sportsground, notably short- or medium-term maintenance recommendations for the ground, in order to lower the average stiffness value of the ground. The maintenance recommendations may include watering, harrowing, decompacting, drainage, keeping in the shade, and exposing to the sun (this list is not exhaustive).

The method may also be implemented to draw up a map of the sportsground as a function of the measurements taken and the locations thereof.

Moreover, the damping coefficient of the ground can be obtained from the slope CA in N/s of the straight line passing through the vertices of the consecutive peaks of the vertical force, during consecutive impacts and rebounds, as illustrated in FIG. 11. This figure shows the evolution over time of the vertical force Fz during operation of the simulation device, with a first bearing and six rebounds. The damping coefficient CA of the ground represents the energy return from the ground to the horse. The damping coefficient CA makes it possible to predict the capacity of a ground to be compacted under the effect of the rebounds of the impactor.

Knowing the stiffness of the ground and this damping coefficient CA can make it possible to issue suitable maintenance recommendations for the ground of an equestrian sportsground, notably short-term maintenance recommendations for the ground. Application of these recommendations is intended on one hand to improve the performance of the ground, notably in sporting terms, and on the other hand to minimize the risk of accidents.

1. A device for simulating the behavior on the ground of a limb of a mammal, including:
an impactor in contact with the ground, which is intended to compress the ground,
a vertical shaft connected to the impactor at the lower end thereof,
a mass that is movable along a vertical rectilinear shaft and is notably intended to cause the descent of the impactor into the ground,
one or more stops placed on one or more vertical rods along which the mass moves, the vertical rod or rods being connected to the vertical shaft by one or more elastic members,
a sensor for measuring the vertical force applied to the impactor, and
a device for measuring the penetration of the impactor into the ground, under the effect of the movement of the mass.

2. The simulation device as claimed in claim 1, wherein the device for measuring the penetration of the impactor into the ground includes a movement sensor, notably a linear potentiometer (12).

3. The simulation device as claimed in claim 1, configured so that the compression speed of the ground is between 50 kN/s and 500 kN/s.

4. The simulation device as claimed in claim 1, configured to provide the average stiffness (Rm) of the ground, which is the ratio of the maximum vertical force (Fz max) to the corresponding penetration (Enf) of the impactor into the ground, and/or the segment stiffnesses for different force levels.

5. The simulation device as claimed in claim 1, configured to provide the damping coefficient of the ground, from the slope of the straight line passing through the vertices of the consecutive peaks of the vertical force (Fz), during consecutive impacts and rebounds.

6. The simulation device as claimed in claim 1, said device being configured to be movable, notably having wheels (35), for example two wheels on which a chassis (30) of the device is mounted.

7. The simulation device as claimed in claim 1, configured to enable consecutive measurements to be taken, separated by an interval of time of less than 15 minutes.

8. The simulation device as claimed in claim 1, wherein the mammal is a human or an animal.

9. The simulation device as claimed in claim 8, wherein the animal mammal is an equine animal, and preferably a horse.

10. A method for determining the accident risk of a sportsground, including an equestrian sportsground, wherein a simulation device as claimed in claim 1 is used to measures at least one of the parameters from the following list: vertical force, maximum vertical force, penetration of the impactor into the ground, maximum penetration of the impactor into the ground, recoil of the ground following impact, average stiffness and segment stiffnesses, and damping coefficient of the ground.

11. The method as claimed in claim 10, wherein an accident risk of the sportsground used by mammals, including the equestrian sportsground, is determined using the measured parameter or parameters.

12. The simulation device as claimed in claim 2, wherein the movement sensor is linear potentiometer.

13. The simulation device as claimed in claim 6, wherein said device is configured to be movable, having wheels on which a chassis of the device is mounted.

14. The simulation device as claimed in claim 7, configured to enable consecutive measurements to be taken, separated by an interval of time of less than 12 minutes.

15. The simulation device as claimed in claim 14, configured to enable consecutive measurements to be taken, separated by an interval of time of less than 10 minutes.

16. The simulation device as claimed in claim 15, configured to enable consecutive measurements to be taken, separated by an interval of time of less than 5 minutes.

17. The simulation device as claimed in claim 9, wherein the animal mammal is a horse.
